(19) United States
(12) Patent Application Publication
(10) Pub. No.: US 2025/0336609 A1
(43) Pub. Date: Oct. 30, 2025

(54) MULTILAYER CERAMIC CAPACITOR

(71) Applicant: Murata Manufacturing Co., Ltd., Nagaokakyo-shi (JP)

(72) Inventors: Hiroki KAWASAKI, Nagaokakyo-shi (JP); Yuri HIYOSHI, Nagaokakyo-shi (JP); Mikio TAKENO, Nagaokakyo-shi (JP)

(21) Appl. No.: 19/173,955

(22) Filed: Apr. 9, 2025

(30) Foreign Application Priority Data
Apr. 26, 2024 (JP) 2024-072783

(51) Int. Cl. H01G 4/30; H01G 4/012; H01G 4/232

(52) U.S. Cl. CPC H01G 4/30; H01G 4/2325; H01G 4/012

(57) ABSTRACT

A multilayer ceramic capacitor includes an element body portion and an external electrode including an end-surface-side external electrode, a main-surface-side external electrode, a side-surface-side external electrode, and a ridgeline-portion-side external electrode. At least one of the main-surface-side external electrode and the side-surface-side external electrode includes a first projecting portion projecting toward a central portion of the element body portion in a length direction, relative to the ridgeline-portion-side external electrode. T0 is equal to or larger than about 2.5 mm, where T0 denotes a maximum distance between the first and second main surfaces. W0 is equal to or larger than about 2.5 mm, where W0 denotes a maximum distance between first and second side surfaces. 0.01×T0≤P1≤0.06×T0 and 0.01×W0≤P1≤0.06×W0 are satisfied, where P1 denotes a maximum projection length of the first projecting portion.

### CROSS REFERENCE TO RELATED APPLICATIONS

This nonprovisional application claims the benefit of Japanese Patent Application No. 2024-072783 filed with the Japan Patent Office on Apr. 26, 2024, the entire contents of this application are hereby incorporated herein by reference.

### BACKGROUND OF THE INVENTION

### 1. Field of the Invention

The present invention relates to multilayer ceramic capacitors.

### 2. Description of the Related Art

Japanese Patent Laid-Open No. 2005-19921 discloses a configuration of a multilayer ceramic capacitor. The multilayer ceramic capacitor described therein includes an element body portion substantially in a shape of a parallelepiped in which a plurality of dielectric layers and a plurality of internal electrode layers are alternately layered and external electrodes provided on a pair of end surfaces in a length direction of the element body portion.

The external electrode not only covers the end surface of the element body portion but also is provided to extend from this end surface to each of four outer peripheral surfaces of the element body portion. The multilayer ceramic capacitor is mounted on an insulating substrate with solder joined to the external electrode being interposed.

In the multilayer ceramic capacitor mounted on the insulating substrate, when the insulating substrate is warped under the influence by externally applied heat or the like, stress is produced in the external electrode. This stress tends to be concentrated in particular at an end located on a central portion side of the element body portion in the length direction, of a portion of the external electrode provided to extend to the outer peripheral surface of the element body portion.

Consequently, a problem of breakage starting from the end may occur in the multilayer ceramic capacitor. This problem is particularly noticeable in the multilayer ceramic capacitor configured such that the end surface of the element body portion is considerably large.

### SUMMARY OF THE INVENTION

Example embodiments of the present invention provide multilayer ceramic capacitors each with improved reliability after being mounted.

A multilayer ceramic capacitor according to an example embodiment of the present invention includes an element body portion and a first external electrode. The element body portion includes a plurality of dielectric layers and a plurality of internal electrode layers layered in a layering direction. The element body portion includes a first main surface and a second main surface opposed to each other in the layering direction, a first side surface and a second side surface opposed to each other in a width direction orthogonal or substantially orthogonal to the layering direction, and a first end surface and a second end surface opposed to each other in a length direction orthogonal or substantially orthogonal to the layering direction and the width direction. The first external electrode extends from the first end surface to each of the first main surface, the second main surface, the first side surface, and the second side surface. The first external electrode is electrically connected to at least one of the plurality of internal electrode layers. The element body portion includes a ridgeline portion where two surfaces adjacent to each other among the first main surface, the second main surface, the first side surface, and the second side surface meet each other. The first external electrode includes an end-surface-side first external electrode, a main-surface-side first external electrode, a side-surface-side first external electrode, and a ridgeline-portion-side first external electrode. The end-surface-side first external electrode covers the first end surface. The main-surface-side first external electrode is connected to the end-surface-side first external electrode and covers a portion of the first main surface and a portion of the second main surface. The side-surface-side first external electrode is connected to the end-surface-side first external electrode and covers a portion of the first side surface and a portion of the second side surface. The ridgeline-portion-side first external electrode is connected to the end-surface-side first external electrode and covers the ridgeline portion. At least one of the main-surface-side first external electrode and the side-surface-side first external electrode includes a first projecting portion projecting toward a central portion of the element body portion in the length direction, relatively to the ridgeline-portion-side first external electrode. T0 is equal to or larger than about 2.5 mm, where T0 denotes a maximum distance between the first main surface and the second main surface. W0 is equal to or larger than about 2.5 mm, where W0 denotes a maximum distance between the first side surface and the second side surface. Expressions (1) and (2) are satisfied

0.01×T0≤P1≤0.06×T0 (1)

0.02 0.01×W0≤P1≤0.06×W0 (2)
where P1 denotes a maximum projection length of the first projecting portion.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view schematically showing a multilayer ceramic capacitor according to an example embodiment of the present invention.

FIG. 2 is a schematic cross-sectional view along the line II-II, of the multilayer ceramic capacitor shown in FIG. 1.

FIG. 3 is a schematic cross-sectional view along the line III-III, of the multilayer ceramic capacitor shown in FIG. 1.

FIG. 4 is a schematic plan view of the multilayer ceramic capacitor viewed from a direction shown with an arrow IV shown in FIG. 1.

FIG. 5 is a partially enlarged view of a portion of the multilayer ceramic capacitor shown in FIG. 4.

FIG. 6 is a flowchart showing a method of manufacturing a multilayer ceramic capacitor according to an example embodiment of the present invention.

FIGS. 7 to 9 are each a schematic cross-sectional view for illustrating step S81 in a flow of manufacturing shown in FIG. 6.

FIGS. 10 and 11 are each a schematic cross-sectional view for illustrating step S82 in the flow of manufacturing shown in FIG. 6.

FIG. 12 is a schematic cross-sectional view of a multilayer ceramic capacitor according to a first modification of an example embodiment of the present invention.

FIG. 13 is a schematic plan view of a multilayer ceramic capacitor according to a second modification of an example embodiment of the present invention.

### DETAILED DESCRIPTION OF THE EXAMPLE EMBODIMENTS

Example embodiments of the present invention will be described in detail below with reference to the drawings. In the example embodiments described below, the same or common elements in the drawings are denoted by the same reference characters and description thereof will not be repeated. In the drawings, a length direction of an element body portion is denoted with L, a width direction of the element body portion is denoted with W, and a layering direction of the element body portion is denoted with T. The element body portion will be described in detail later.

### EXAMPLE EMBODIMENTS

### A. Configuration of Multilayer Ceramic Capacitor

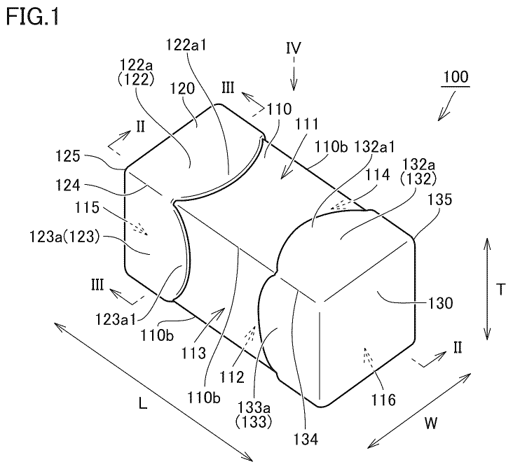

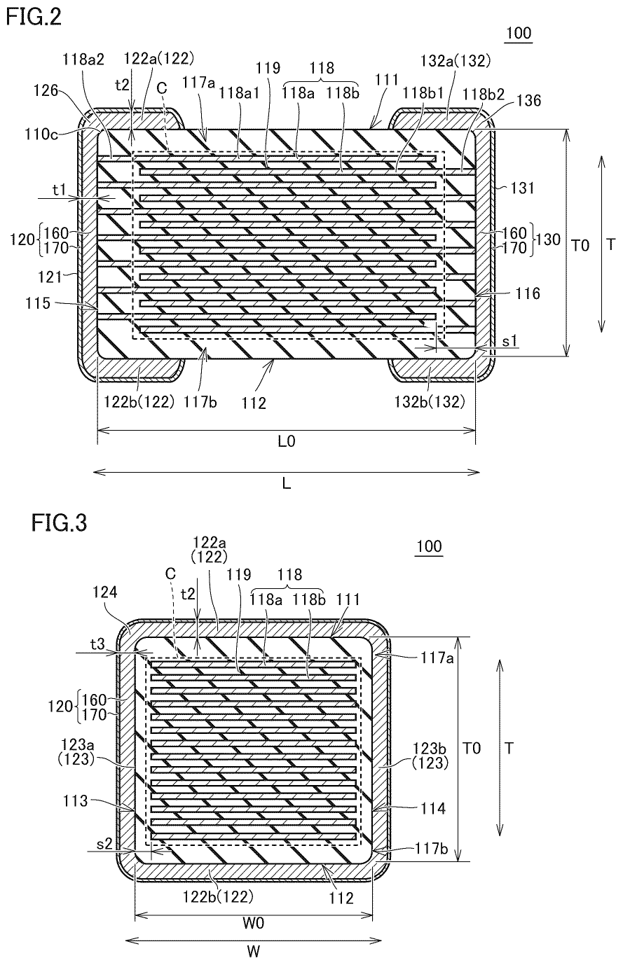

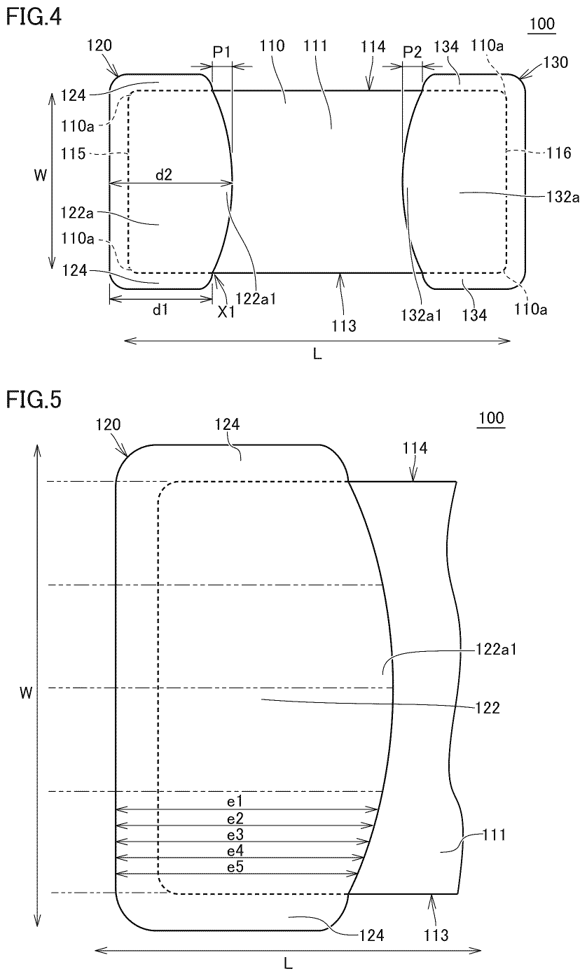

FIG. 1 is a perspective view schematically showing a multilayer ceramic capacitor according to an example embodiment of the present invention. FIG. 2 is a schematic cross-sectional view along the line II-II, of the multilayer ceramic capacitor shown in FIG. 1. FIG. 3 is a schematic cross-sectional view along the line III-III, of the multilayer ceramic capacitor shown in FIG. 1. FIG. 4 is a schematic plan view of the multilayer ceramic capacitor viewed from a direction shown with an arrow IV shown in FIG. 1. FIG. 5 is a partially enlarged view of a part of the multilayer ceramic capacitor shown in FIG. 4. A configuration of a multilayer ceramic capacitor 100 according to the present example embodiment will initially be described with reference to FIGS. 1 to 5.

As shown in FIGS. 1 to 4, multilayer ceramic capacitor 100 according to the present example embodiment includes an element body portion 110 and an external electrode. The external electrode includes a first external electrode 120 and a second external electrode 130.

Element body portion 110 is in or substantially in a shape of a parallelepiped. Element body portion 110 is provided with a first main surface 111 and a second main surface 112 opposed to each other in a layering direction T, a first side surface 113 and a second side surface 114 opposed to each other in a width direction W orthogonal or substantially orthogonal to layering direction T, and a first end surface 115 and a second end surface 116 opposed to each other in a length direction L orthogonal or substantially orthogonal to layering direction T and width direction W. By way of example, in the present example embodiment, second main surface 112 defines a mount surface to mount multilayer ceramic capacitor 100 on an insulating substrate.

Element body portion 110 includes a plurality of corner portions 110a. Corner portion 110a is a portion where three surfaces of element body portion 110 meet one another. Specifically, the plurality of corner portions 110a include portions where three surfaces adjacent to one another among first main surface 111, second main surface 112, first side surface 113, second side surface 114, first end surface 115, and second end surface 116 meet one another. The plurality of corner portions 110a are preferably each rounded.

Element body portion 110 includes a plurality of ridgeline portions 110b. The plurality of ridgeline portions 110b include portions where two surfaces adjacent to each other among first main surface 111, second main surface 112, first side surface 113, and second side surface 114 meet each other. The plurality of ridgeline portions 110b are preferably each rounded.

Element body portion 110 includes a plurality of end-surface-side ridgeline portions 110c. The plurality of end-surface-side ridgeline portions 110c include a portion where first end surface 115 meet each of first main surface 111, second main surface 112, first side surface 113, and second side surface 114 and a portion where second end surface 116 meets each of first main surface 111, second main surface 112, first side surface 113, and second side surface 114. The plurality of end-surface-side ridgeline portions 110c are preferably each rounded.

Element body portion 110 is configured such that first end surface 115 and second end surface 116 are relatively large. More specifically, as shown in FIGS. 2 and 3, for example, T0 is equal to or larger than about 2.5 mm and W0 is equal to or larger than about 2.5 mm, where T0 denotes a maximum distance between first main surface 111 of second main surface 112 of element body portion 110, and W0 denotes a maximum distance between first side surface 113 and second side surface 114.

A maximum distance L0 between first end surface 115 and second end surface 116 of element body portion 110 is, for example, not shorter than about 3.05 mm and not longer than about 3.2 mm.

Element body portion 110 has, for example, a length dimension L0 of about 3.1 mm, a width dimension W0 of about 2.5 mm, and a thickness dimension T0 of about 2.5 mm. A tolerance is included in these dimensions.

First external electrode 120 is provided over the entire or substantially the entire first end surface 115. First external electrode 120 extends from first end surface 115 to each of first main surface 111, second main surface 112, first side surface 113, and second side surface 114.

Second external electrode 130 is provided over the entire or substantially the entire second end surface 116. Second external electrode 130 extends from second end surface 116 to each of first main surface 111, second main surface 112, first side surface 113, and second side surface 114.

A detailed configuration of first external electrode 120 and second external electrode 130 will be described later.

As shown in FIGS. 2 and 3, element body portion 110 includes a first outer layer 117a defined by a dielectric layer and including first main surface 111, a second outer layer 117b defined by a dielectric layer and including second main surface 112, and a plurality of internal electrode layers 118 layered alternately with dielectric layers between first outer layer 117a and second outer layer 117b.

In the present example embodiment, the dielectric layer that defines first outer layer 117a and the dielectric layer that defines second outer layer 117b include substantially the same ceramic material. Including substantially the same ceramic material means having substantially the same ratio of a ceramic material prepared as a source material, and a range of variation in ceramic composition due to variations in ratio of preparation and process step is included in being substantially the same ceramic material.

The plurality of internal electrode layers 118 include a first internal electrode layer 118a and a second internal electrode layer 118b. First internal electrode layer 118a and second internal electrode layer 118b are alternately layered inside element body portion 110 along layering direction T. A plurality of first internal electrode layers 118a and a plurality of second internal electrode layers 118b are each provided in parallel or substantially in parallel to length direction L and width direction W. A dielectric layer 119 is arranged between first internal electrode layer 118a and second internal electrode layer 118b adjacent in layering direction T. In other words, first internal electrode layer 118a and second internal electrode layer 118b adjacent in layering direction T are opposed to each other with dielectric layer 119 therebetween.

First internal electrode layer 118a extends to first end surface 115. First end surface 115 is covered with first external electrode 120. First external electrode 120 is electrically connected to first internal electrode layer 118a. Second internal electrode layer 118b extends to second end surface 116. Second end surface 116 is covered with second external electrode 130. Second external electrode 130 is electrically connected to second internal electrode layer 118b.

Although FIGS. 2 and 3 show an example where seven first internal electrode layers 118a and seven second internal electrode layers 118b are provided, each of the number of first internal electrode layers 118a and the number of second internal electrode layers 118b is not particularly limited to seven. The total of the number of first internal electrode layers 118a and the number of second internal electrode layers 118b is, for example, preferably not smaller than 300 and not larger than 600. A thickness of each of first internal electrode layer 118a and second internal electrode layer 118b is, for example, preferably not smaller than about 0.9 μm and not larger than about 10 μm.

First internal electrode layer 118a includes a first opposing portion 118a1 and a first drawn portion 118a2. First opposing portion 118a1 is opposed to second internal electrode layer 118b adjacent in layering direction T. First drawn portion 118a2 connects first opposing portion 118a1 and first external electrode 120 to each other. First drawn portion 118a2 extends toward first end surface 115. First opposing portion 118a1 and first drawn portion 118a2 are integrally provided.

Second internal electrode layer 118b includes a second opposing portion 118b1 and a second drawn portion 118b2. Second opposing portion 118b1 is opposed to first internal electrode layer 118a adjacent in layering direction T. Second drawn portion 118b2 connects second opposing portion 118b1 and second external electrode 130 to each other. Second drawn portion 118b2 extends toward second end surface 116. Second opposing portion 118b1 and second drawn portion 118b2 are integrally provided.

Each of first internal electrode layer 118a and second internal electrode layer 118b includes a metal such as, for example, Ni, Cu, Ag, Pd, or Au or an alloy including the metal. Examples of such an alloy include an alloy of Ag and Pd and the like. In the present example embodiment, for example, each of first internal electrode layer 118a and second internal electrode layer 118b includes Ni as a main component. Each of first internal electrode layer 118a and second internal electrode layer 118b may further include, for example, dielectric particles including the same composition as ceramic contained in dielectric layer 119. Each of first internal electrode layer 118a and second internal electrode layer 118b may include, for example, Sn at an interface with dielectric layer 119.

A plurality of dielectric layers 119 include an outer dielectric layer located between internal electrode layer 118 located closest to first main surface 111 in layering direction T and first main surface 111 and an outer dielectric layer located between internal electrode layer 118 located closest to second main surface 112 in layering direction T and second main surface 112 and an inner dielectric layer located between internal electrode layers 118 adjacent in layering direction T. The number of dielectric layers 119 is, for example, preferably not smaller than 300 and not larger than 800. A thickness of the outer dielectric layer is, for example, preferably not smaller than about 20 μm and not larger than about 50 μm. A thickness of the inner dielectric layer is, for example, preferably not smaller than about 3 μm and not larger than about 10 μm.

For each of the plurality of dielectric layers 119, for example, dielectric ceramic including, for example, BaTiO₃, CaTiO₃, SrTiO₃, or CaZrO₃ can be used as a ceramic material. A material obtained by adding a sub component such as, for example, a Mn compound, a Fe compound, a Cr compound, a Co compound, or a Ni compound to the main component may be used.

Element body portion 110 includes an inner layer portion C. Inner layer portion C generates a capacitance as a result of layering of first opposing portion 118a1 of first internal electrode layer 118a and second opposing portion 118b1 of second internal electrode layer 118b in layering direction T.

A distance s1 (see FIG. 2) between an end of first internal electrode layer 118a on a side of second end surface 116 and second end surface 116 is, for example, preferably not shorter than about 1.6 mm and not longer than about 6.0 mm. A distance between an end of second internal electrode layer 118b on a side of first end surface 115 and first end surface 115 is also the same or similar.

A distance s2 (see FIG. 3) between first internal electrode layer 118a and second internal electrode layer 118b, and first side surface 113 is, for example, preferably not shorter than about 0.8 mm and not longer than about 3.0 mm. A distance between first internal electrode layer 118a and second internal electrode layer 118b, and second side surface 114 is also the same or similar.

### B. Detailed Configuration of External Electrode

A detailed configuration of the external electrode will be described below with reference to FIGS. 1 to 5. As described above, the external electrode includes first external electrode 120 and second external electrode 130.

First external electrode 120 and second external electrode 130 each include an underlying electrode layer 160 and a plated layer 170 that covers underlying electrode layer 160.

Underlying electrode layer 160 includes, for example, at least one of a baked layer, a resin layer, a thin-film layer, or the like. In the present example embodiment, underlying electrode layer 160 is, for example, the baked layer.

The baked layer includes a glass component and a metallic component. The metallic component includes, for example, Ni, Cu, Ag, Pd, or Au or an alloy including these metals, and for example, an alloy of Ag and Pd or the like can be used. The glass component includes, for example, at least one of Si or Zn.

The baked layer may include a plurality of layers that are layered. The baked layer may be made by, for example, application of a conductive paste to element body portion 110 and baking the conductive paste or a layer obtained by firing simultaneous with firing of internal electrode layer 118.

Plated layer 170 is arranged on underlying electrode layer 160. One type of metal including, for example, Ni, Cu, Ag, Pd, or Au or an alloy including these metals or the like can be used as a material for plated layer 170. By way of example, an alloy of Ag and Pd can be used as the material for plated layer 170.

In the present example embodiment, for example, plated layer 170 includes a Ni layer located on a side of underlying electrode layer 160 and a Sn layer located opposite to underlying electrode layer 160. Specifically, plated layer 170 has a two-layered structure including a Sn-plated layer on a Ni-plated layer.

The Ni-plated layer can prevent erosion of underlying electrode layer 160 by solder used in mount of multilayer ceramic capacitor 100 on the insulating substrate. The Sn-plated layer can improve solderability in this mount and thus facilitate mount of multilayer ceramic capacitor 100.

First external electrode 120 includes an end-surface-side first external electrode 121, a main-surface-side first external electrode 122, a side-surface-side first external electrode 123, a ridgeline-portion-side first external electrode 124, a corner-portion-side first external electrode 125, and an end-surface-side and ridgeline-portion-side first external electrode 126. Main-surface-side first external electrode 122, side-surface-side first external electrode 123, ridgeline-portion-side first external electrode 124, corner-portion-side first external electrode 125, and end-surface-side and ridgeline-portion-side first external electrode 126 are connected to end-surface-side first external electrode 121.

End-surface-side first external electrode 121 covers the entire or substantially the entire first end surface 115. Main-surface-side first external electrode 122 covers a portion of first main surface 111 located on the side of first end surface 115 and a portion of second main surface 112 located on the side of first end surface 115. Side-surface-side first external electrode 123 covers a portion of first side surface 113 located on the side of first end surface 115 and a portion of second side surface 114 located on the side of first end surface 115. Ridgeline-portion-side first external electrode 124 covers portions of the plurality of ridgeline portions 110b located on the side of first end surface 115. Corner-portion-side first external electrode 125 covers portions of the plurality of corner portions 110a located on the side of first end surface 115. End-surface-side and ridgeline portion-side first external electrode 126 covers portions of the plurality of end-surface-side ridgeline portions 110c located on the side of first end surface side 115.

As shown in FIGS. 1 to 4, main-surface-side first external electrode 122 includes a first main-surface-side first external electrode 122a covering a portion of first main surface 111 and a second main-surface-side first external electrode 122b covering a portion of second main surface 112.

As shown in FIG. 4, first main-surface-side first external electrode 122a includes a first projecting portion 122a1. First projecting portion 122a1 projects toward a central portion of element body portion 110 in length direction L, relatively to ridgeline-portion-side first external electrode 124. An edge of first projecting portion 121a1 located on a central portion side of element body portion 110 has an arc shape.

First projecting portion 122a1 is configured to have a considerably short maximum projection length. More specifically, expressions (1) and (2) below are satisfied where P1 denotes the maximum projection length of first projecting portion 122a1. As described above, T0 denotes the maximum distance between first main surface 111 and second main surface 112 of element body portion 110 and W0 denotes the maximum distance between first side surface 113 and second side surface 114.

0.01×T0≤P1≤0.06×T0 (1)

0.02 0.01×W0≤P1≤0.06×W0 (2)

According to such a configuration, multilayer ceramic capacitor 100 having improved reliability after being mounted can be obtained, which will be described later in detail.

P1 can be determined by observing multilayer ceramic capacitor 100 in a direction of a plan view.

Initially, a distance d1 from an outermost portion in length direction L, of a surface of end-surface-side first external electrode 121 to an end of ridgeline-portion-side first external electrode 124 arranged adjacently to first main-surface-side first external electrode 122a is measured. Ridgeline-portion-side first external electrode 124 arranged adjacently to first main-surface-side first external electrode 122a includes a portion located on a side of first side surface 113 and a portion located on a side of second side surface 114. Therefore, distance d1 is measured for each of these two portions, and a longer one of two measured distances d1 is used. The end of the portion of ridgeline-portion-side first external electrode 124 located on the side of first side surface 113 refers to a portion of first external electrode 120 that intersects with a ridgeline provided at a portion where first main surface 111 and first side surface 113 meet each other when multilayer ceramic capacitor 100 is viewed in a plan view (see a position Xl in FIG. 4), which is also similarly applicable to the end of the portion of ridgeline-portion-side first external electrode 124 located on the side of second side surface 114.

A distance d2 along length direction L from the outermost portion in length direction L, of the surface of end-surface-side first external electrode 121 to an outermost projecting portion of first projecting portion 122a1 is then measured.

Distance d1 is then subtracted from distance d2. A value thus calculated is expressed as P1 described above.

In connection with an average dimension in length direction L of each of four portions of first main-surface-side first external electrode 122a which result from dividing first main-surface-side first external electrode 122a into four equal or substantially equal portions in width direction W, a rate of change between average dimensions of portions adjacent to each other is, for example, not higher than about 20%. The rate of change refers to a value calculated by dividing an absolute value of a difference between two average dimensions by the average dimension smaller in value of the two average dimensions. When values of the two average dimensions are equal to each other, the rate of change is 00.

The average dimension in length direction L of each of the four portions is calculated by observing multilayer ceramic capacitor 100 in the direction of the plan view. A method of calculating the average dimension of the portion located closest to first side surface 113 among the four portions will be described with reference to FIG. 5, by way of example.

Initially, first main-surface-side first external electrode 122a is divided into four equal or substantially equal portions in width direction W (see chain double-dotted line in FIG. 5). Then, at five locations equidistant or substantially equidistant in width direction W in one of the four equal or substantially equal portions of first main-surface-side first external electrode 122a, distances e1 to e5 along length direction L from the outermost portion in length direction L, of the surface of end-surface-side first external electrode 121 to the end of first main-surface-side first external electrode 122a are measured. In measurement at these five locations, an interval in width direction W between adjacent measurement locations is assumed to be equal or substantially equal to an interval when dividing one of the four equal or substantially equal portions of first main-surface-side first external electrodes 122a into six equal or substantially equal portions in width direction W.

An average value of five measurement values thus obtained is then calculated. The average value thus calculated is used as the average dimension described above.

Although description will not be provided, second main-surface-side first external electrode 122b has the same or similar configuration to that of first main-surface-side first external electrode 122a described above.

As shown in FIGS. 1 and 3, side-surface-side first external electrode 123 includes a first side-surface-side first external electrode 123a covering a portion of first side surface 113 and a second side-surface-side first external electrode 123b covering a portion of second side surface 114.

First side-surface-side first external electrode 123a includes a first projecting portion 123a1. First projecting portion 123a1 projects toward the central portion of element body portion 110 in length direction L, relative to ridgeline-portion-side first external electrode 124. An end of first projecting portion 123a1 located on the central portion side of element body portion 110 has an arc shape.

The configuration of first side-surface-side first external electrode 123a and first projecting portion 123a1 (more specifically, the rate of change in length in length direction L, of first side-surface-side first external electrode 123a and a projection length of first projecting portion 123a1) is the same as or similar to the configuration of first main-surface-side first external electrode 122a and first projecting portion 122a1 described above.

Specifically, the expressions (1) and (2) above are satisfied where P1 denotes the projection length of first projecting portion 123a1. In connection with the average dimension in length direction L of each of four portions of first side-surface-side first external electrode 123a which result from dividing first side-surface-side first external electrode 123a into four equal or substantially equal portions in layering direction T, the rate of change between the average dimensions of portions adjacent to each other is, for example, not higher than about 20%.

Although P1 denotes both of the projection length of first projecting portion 122a1 of first main-surface-side first external electrode 122a and the projection length of first projecting portion 123a1 of first side-surface-side first external electrode 123a, it does not necessarily mean that the projection length of first projecting portion 122a1 is equal or substantially equal to the projection length of first projecting portion 123a1.

Although description will not be provided, second side-surface-side first external electrode 123b has the same or similar configuration as that of first side-surface-side first external electrode 123a described above.

When the thickness of end-surface-side first external electrode 121 is smaller than a prescribed thickness, it is difficult to ensure reliability of first external electrode 120 as a drawn electrode. On the other hand, on the premise that a size of an outer geometry of multilayer ceramic capacitor 100 is not changed, when the thickness of end-surface-side first external electrode 121 becomes larger than the prescribed thickness, inner layer portion C accordingly becomes smaller and it becomes difficult to ensure a capacitance of multilayer ceramic capacitor 100.

From this point of view, as shown in FIGS. 2 and 3, end-surface-side first external electrode 121 preferably satisfies, for example, a condition of 0.006×L0≤t1≤0.015×L0, t1 denoting a maximum thickness of the end-surface-side first external electrode, and more suitably, for example, it satisfies a condition of t1≤0.008×L0. The thickness of end-surface-side first external electrode 121 is, for example preferably not smaller than about 20 μm and not larger than about 120 μm. A difference between the maximum thickness of end-surface-side first external electrode 121 and the maximum thickness of an end-surface-side second external electrode 131 is, for example, preferably equal to or larger than about 20 μm.

At least one of expressions (3) and (4) below is preferably satisfied, where t2 denotes a maximum thickness of main-surface-side first external electrode 122 and t3 denotes a maximum thickness of side-surface-side first external electrode 123. Strength of multilayer ceramic capacitor 100 mounted on the insulating substrate against stress applied to multilayer ceramic capacitor 100 can thus be improved.

0.008×T0≤t2 (3)

0.008×W0≤t3 (4)

t2 and t3 are, for example, preferably and more suitably not smaller than about 30 μm and smaller than about 40 μm. A difference between the maximum thickness of main-surface-side first external electrode 122 and a maximum thickness of a main-surface-side second external electrode 132 which will be described later is, for example, preferably equal to or larger than about 5 μm. Similarly, a difference between the maximum thickness of side-surface-side first external electrode 123 and a maximum thickness of a side-surface-side second external electrode 133 which will be described later is, for example, preferably equal to or larger than about 5 μm.

t1 and t2 can be determined, for example, by polishing multilayer ceramic capacitor 100 so as to expose an L-T cross-section of a portion of multilayer ceramic capacitor 100 which is located in the center in width direction W and observing with an electron microscope or the like, a portion of the cross-section where end-surface-side first external electrode 121 is located. t1 and t3 can be determined, for example, also by polishing multilayer ceramic capacitor 100 so as to expose an L-W cross-section of a portion of multilayer ceramic capacitor 100 which is located in the center in layering direction T and observing the cross-section.

In the determination of t2, the maximum thickness of first main-surface-side first external electrode 122a and the maximum thickness of second main-surface-side first external electrode 122b are measured and a value of the smaller thickness is used. Similarly, in the determination of t3, the maximum thickness of first side-surface-side first external electrode 123a and the maximum thickness of second side-surface-side first external electrode 123b are measured and a value of the smaller thickness is used.

A length dimension along length direction L from the outermost portion in length direction L, of the surface of end-surface-side first external electrode 121 to the end of ridgeline-portion-side first external electrode 124 located on a side of second external electrode 130 is, for example, not smaller than about 500 μm and not larger than about 600 μm.

A difference in thickness between a largest thickness portion and a smallest thickness portion of end-surface-side and ridgeline-portion-side first external electrode 126 is, for example, preferably equal to or smaller than about 2.0 μm.

Second external electrode 130 includes end-surface-side second external electrode 131, main-surface-side second external electrode 132, side-surface-side second external electrode 133, a ridgeline-portion-side second external electrode 134, a corner-portion-side second external electrode 135, and an end-surface-side and ridgeline-portion-side second external electrode 136. Main-surface-side second external electrode 132, side-surface-side second external electrode 133, ridgeline-portion-side second external electrode 134, corner-portion-side second external electrode 135, and end-surface-side and ridgeline-portion-side second external electrode 136 are connected to end-surface-side second external electrode 131.

End-surface-side second external electrode 131 covers the entire or substantially the entire second end surface 116. Main-surface-side second external electrode 132 covers a portion of first main surface 111 located on the side of second end surface 116 and a portion of second main surface 112 located on the side of second end surface 116. Side-surface-side second external electrode 133 covers a portion of first side surface 113 located on the side of second end surface 116 and a portion of second side surface 114 located on the side of second end surface 116. Ridgeline-portion-side second external electrode 134 covers portions of the plurality of ridgeline portions 110b located on the side of second end surface 116. Corner-portion-side second external electrode 135 covers portions of the plurality of corner portions 110a located on the side of second end surface 116. End-surface-side and ridgeline-portion-side second external electrode 136 covers portions of the plurality of end-surface-side ridgeline portions 110c located on the side of second end surface 116.

As shown in FIGS. 1 and 2, main-surface-side second external electrode 132 includes a first main-surface-side second external electrode 132a which is a portion that covers a portion of first main surface 111 and a second main-surface-side second external electrode 132b which is a portion that covers a portion of second main surface 112. Side-surface-side second external electrode 133 includes a first side-surface-side second external electrode 133a which is a portion that covers a portion of first side surface 113 and a second side-surface-side second external electrode which is a portion that covers a portion of second side surface 114.

First main-surface-side second external electrode 132a includes a second projecting portion 132a1. Second projecting portion 132a1 projects toward the central portion of element body portion 110 in length direction L, relative to ridgeline-portion-side second external electrode 134. An end of second projecting portion 132a1 located on the central portion side of element body portion 110 has an arc shape.

Expressions (5) and (6) below are satisfied, where P2 denotes a maximum projection length of second projecting portion 132a1.

0.01×T0≤P2≤0.06×T0 (5)

0.01×W0≤P2≤0.06×W0 (6)

Second main-surface-side second external electrode 132b, first side-surface-side second external electrode 133a, and the second side-surface-side second external electrode also each include a second projecting portion similar in configuration to second projecting portion 132a1 of first main-surface-side second external electrode 132a.

Although description will not be provided, second external electrode 130 is otherwise also similar in configuration to first external electrode 120 described above.

### C. Method of Manufacturing Multilayer Ceramic Capacitor

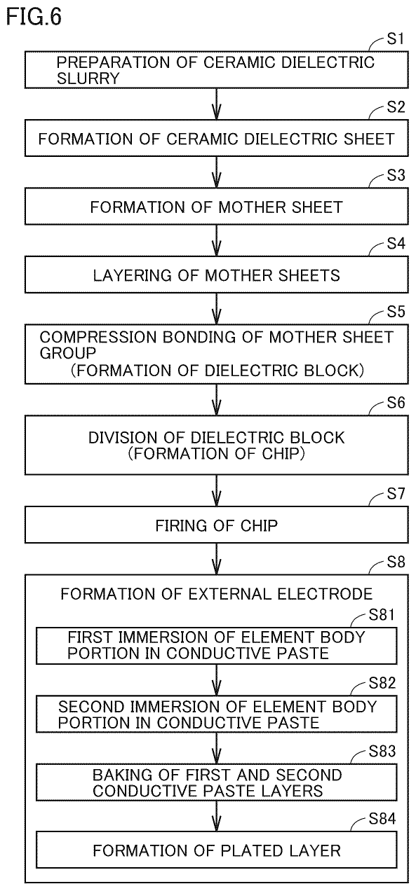

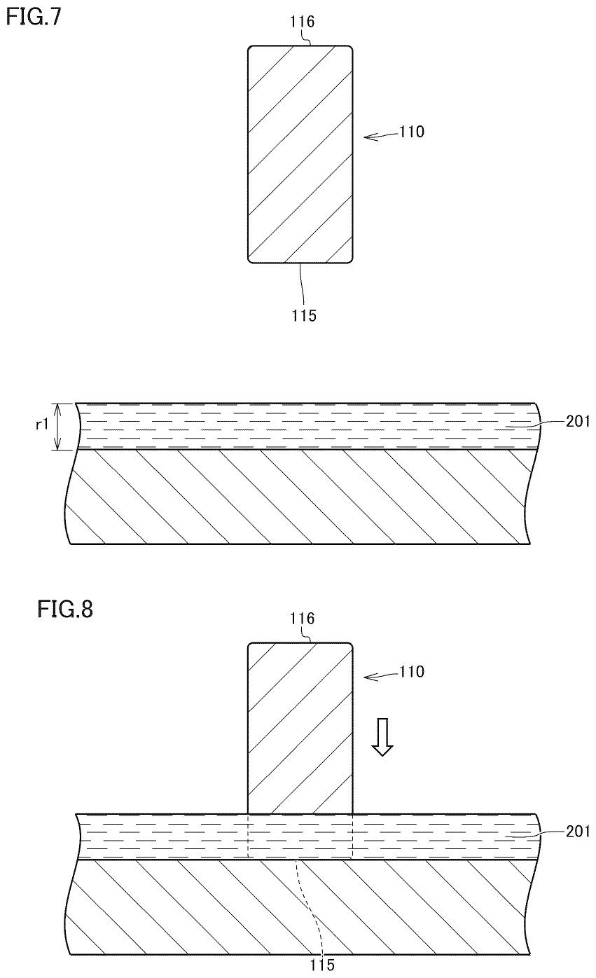

FIG. 6 is a flowchart showing an example of a method of manufacturing a multilayer ceramic capacitor according to an example embodiment of the present invention. FIGS. 7 to 11 are each a schematic cross-sectional view for illustrating steps in a flow of manufacturing shown in FIG. 6. A method of manufacturing multilayer ceramic capacitor 100 according to the present example embodiment will be described below. FIGS. 7 to 11 do not show a detailed structure inside element body portion 110.

Initially, as shown in FIG. 6, ceramic dielectric slurry is prepared (step S1). Specifically, for example, ceramic dielectric powders, additive powders, binder resin, and the like are mixed as being dispersed in a solution. Ceramic dielectric slurry is thus prepared.

Ceramic dielectric powders are, for example, dielectric particles having a perovskite structure and made of BaTiO₃, CaTiO₃, SrTiO₃, CaZrO₃, CaHfO₃, or the like. Additive powders including, for example, at least one of an Si compound, an Mg compound, an Mn compound, an Fe compound, a Cr compound, an Ni compound, or a Co compound may also be included. Polyurethane resin, urea resin, melamine resin, epoxy resin, vinyl acetate resin, acrylic resin, an aqueous polymer such as polyvinyl alcohol (PV) or polyvinyl butyral (PVB), or the like, for example, can be used as the binder resin. One of them may be used alone, or two or more of them may be used as being mixed. Ceramic dielectric slurry may be solvent-based or water-based. In an example where ceramic dielectric slurry is an aqueous paint, the ceramic dielectric slurry is prepared by mixing water-soluble binder, a dispersant, and the like with a dielectric source material dissolved in water.

A ceramic dielectric sheet is then formed (step S2). Specifically, ceramic dielectric slurry is formed into a sheet on a carrier film with the use of, for example, a die coater, a gravure coater, a micro gravure coater, or the like and then dried. A ceramic dielectric sheet is thus formed. A thickness of the ceramic dielectric sheet is, for example, preferably not smaller than about 0.4 μm and not larger than about 0.8 μm from a point of view of reduction in size and a larger capacity of the multilayer ceramic capacitor.

A mother sheet is then formed (step S3). Specifically, a conductive paste is applied to the ceramic dielectric sheet to have a prescribed pattern. The mother sheet in which a prescribed internal electrode pattern has been provided on the ceramic dielectric sheet is thus formed. The conductive paste is prepared to include, for example, Ni powders, a solvent, a dispersant, a binder, and the like and to have a constant viscosity. PVA, PVB, or the like, for example, is used as the binder. A screen printing method, an ink-jet method, a gravure printing method, or the like, for example, can be used as a method of applying the conductive paste. A thickness of the internal electrode pattern is, for example, preferably not smaller than about 0.3 μm and not larger than about 0.8 μm from a point of view of reduction in size and a larger capacity of the multilayer ceramic capacitor. Other than the mother sheet provided with the internal electrode pattern, a ceramic dielectric sheet not subjected to step S3 is also prepared as the mother sheet.

A plurality of mother sheets are then layered (step S4) Specifically, a prescribed number of mother sheets not provided with the internal electrode pattern and formed only from the ceramic dielectric sheets are layered, for example, to a thickness not smaller than about 10 μm and not larger than about 30 μm. A prescribed number of mother sheets provided with the internal electrode pattern are layered thereon. The number of layered mother sheets provided with the internal electrode pattern is, for example, not smaller than 1 and not larger than 1000. Further thereon, a prescribed number of mother sheets not provided with the internal electrode pattern and formed only from the ceramic dielectric sheets are layered, for example, to a thickness not smaller than about 10 μm and not larger than about 30 μm. A mother sheet group is thus made.

A dielectric block is then formed by compression bonding of the mother sheet group (step S5). Specifically, a pressure is applied to the mother sheet group in the layering direction by, for example, a hydrostatic press or a rigid press and the mother sheet group is compression bonded. A dielectric block is thus formed. At this time, as a result of pressing of ceramic dielectric sheets at a prescribed temperature, the ceramic dielectric sheets are brought in intimate contact with each other. Ceramic dielectric sheets as thick as a certain thickness are arranged at an outermost layer in the layering direction and pressed. The dielectric sheets provided with the internal electrode pattern can thus be protected.

The dielectric block is then divided to form chips (step S6). Specifically, the dielectric block is divided in matrices by, for example. press cutting, dicing, or laser cutting and singulated into chips. In division of the dielectric block, the dielectric block may be divided as being heated to soften.

The chips are then fired (step S7). Specifically, as the chips are heated, a dielectric material and a conductive material included in the chips are fired so that element body portion 110 is formed. A firing temperature is, for example, not lower than about 900° C. and not higher than about 1300° C. The firing temperature is set as appropriate in accordance with the dielectric material and the conductive material.

The external electrode is then formed (step S8). This step includes steps S81 to S84 which will be described below.

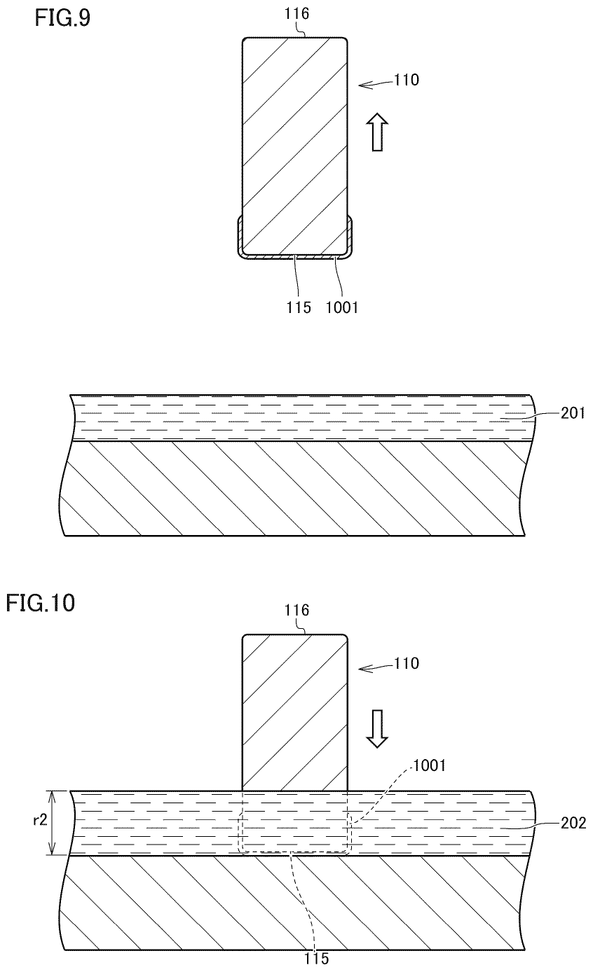

Initially, as shown in FIGS. 7 to 9, first immersion of the element body portion in a conductive paste is performed (step S81). Specifically, one of first end surface 115 and second end surface 116 of element body portion 110 is immersed in a conductive paste 201 (see an arrow in FIG. 8) and thereafter element body portion 110 is removed from conductive paste 201 (see an arrow in FIG. 9). A first conductive paste layer 1001 including conductive paste 201 is thus applied to the end surface and portions of first main surface 111, second main surface 112, first side surface 113, and second side surface 114 adjacent thereto. By way of example, in the present example embodiment, first end surface 115 is immersed in conductive paste 201.

A thickness of conductive paste 201 prepared in first immersion is preferably smaller than a thickness of a conductive paste 202 prepared in second or subsequent immersion which will be described later. Specifically, a dimension r1 in FIG. 7 is preferably smaller than a dimension r2 in FIG. 10. Introduction of air bubbles in first conductive paste layer 1001 can thus be effectively reduced or prevented.

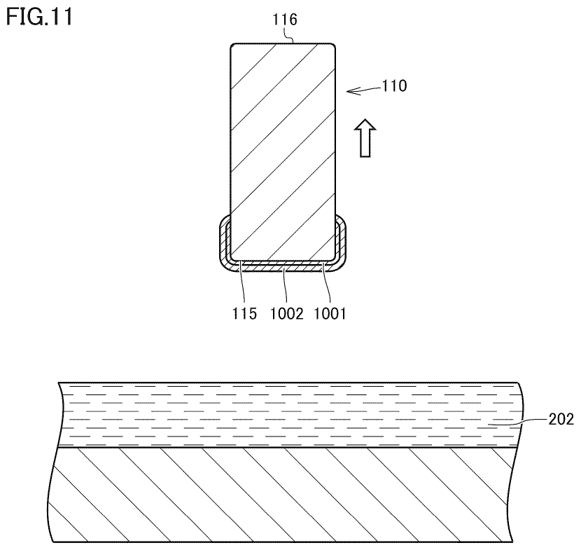

As shown in FIGS. 10 and 11, second immersion of the element body portion in a conductive paste is then performed (step S82). Specifically, first end surface 115 to which first conductive paste layer 1001 has been applied in step S81 is immersed in conductive paste 202 (see an arrow in FIG. 10) and thereafter element body portion 110 is removed from conductive paste 202 (see an arrow in FIG. 11). A second conductive paste layer 1002 including conductive paste 202 is thus applied by wetting up to first end surface 115, first main surface 111, second main surface 112, first side surface 113, and second side surface 114 as being overlaid on first conductive paste layer 1001.

In the present example embodiment, immersion of the element body portion in the conductive paste is performed, for example, two times in total. As the element body portion is thus immersed in the conductive paste a plurality of times, first projecting portion 122a1 provided at first main-surface-side first external electrode 122a described above can be formed to satisfy the expressions (1) and (2) above. In wetting of first main surface 111 with second conductive paste layer 1002 from the side of first end surface 115, second conductive paste layer 1002 should extend over first conductive paste layer 1001, and thus application of second conductive paste layer 1002 to first main surface 111 more than necessary can be avoided.

After step S82, immersion of the element body portion in the conductive paste may further be performed repeatedly.

Step S81 and step S82 described above are then similarly performed also for second end surface 116. At this time, second projecting portion 132a1 can also be formed at first main-surface-side second external electrode 132a and the like to satisfy the expressions (5) and (6) above, by a plurality of times of immersion of the element body portion in the conductive paste.

The first and second conductive paste layers are then baked (step S83). Specifically, first conductive paste layer 1001 and second conductive paste layer 1002 applied to first end surface 115 and portions therearound and second end surface 116 and portions therearound are heated so that a baked layer is formed. A baking temperature is, for example, not lower than about 700° C. and not higher than about 900° C. The baking temperature can be varied as appropriate depending on the dielectric material and the conductive material.

A plated layer is then formed on a surface of the baked layer (step S84). Through the steps described above, multilayer ceramic capacitor 100 according to the present example embodiment can be manufactured.

### D. Summary

In multilayer ceramic capacitor 100 according to the present example embodiment, as described above, for example, T0 is equal to or larger than about 2.5 mm and W0 is equal to or larger than about 2.5 mm, T0 denoting the maximum distance between first main surface 111 and second main surface 112 of element body portion 110, W0 denoting the maximum distance between first side surface 113 and second side surface 114. The expressions (1) and (2) described above are satisfied, where P1 denotes the maximum projection length of first projecting portion 122a1.

Thus, in multilayer ceramic capacitor 100 configured such that first end surface 115 and second end surface 116 of element body portion 110 are relatively large, first projecting portion 122a1 is configured to have a relatively short maximum projection length, so that reliability of multilayer ceramic capacitor 100 after it is mounted can be improved.

Specifically, in multilayer ceramic capacitor 100 mounted on the insulating substrate, when the insulating substrate is warped, stress tends to be concentrated at the end located on the central portion side of element body portion 110 in length direction L, of the portion of first external electrode 120 provided to extend to first main surface 111, second main surface 112, first side surface 113, and second side surface 114 of element body portion 110. For example, with attention being paid to first main-surface-side first external electrode 122a, stress tends to be concentrated at the end of first projecting portion 122a1 in length direction L. This is also applicable to second main-surface-side first external electrode 122b, first side-surface-side first external electrode 123a, and second side-surface-side first external electrode 123b.

Accordingly, multilayer ceramic capacitor 100 according to the present example embodiment is configured such that the maximum projection length of first projecting portion 122a1 is relatively short as described above. Thus, as compared with a configuration in which the maximum projection length of first projecting portion 122a1 is relatively long, concentration of stress at the end of first projecting portion 122a1 can be effectively reduced or prevented. The advantageous effects are also similarly achieved in second main-surface-side first external electrode 122b, first side-surface-side first external electrode 123a, and second side-surface-side first external electrode 123b.

Therefore, according to the configuration described above, the multilayer ceramic capacitor with improved reliability after it is mounted can be obtained.

In multilayer ceramic capacitor 100 according to the present example embodiment, as described above, first main-surface-side second external electrode 132a includes second projecting portion 132a1, and the expressions (5) and (6) described above are satisfied, where P2 denotes the maximum projection length of second projecting portion 132a1. According to such a configuration, concentration of stress at the end of second projecting portion 132a1 in length direction L can also be effectively reduced or prevented. The advantageous effects are also similarly achieved in second main-surface-side second external electrode 132b, first side-surface-side second external electrode 133a, and the second side-surface-side second external electrode.

Therefore, breakage in both of first external electrode 120 and second external electrode 130 provided at opposing ends of element body portion 110 can be effectively reduced or prevented.

Although an example in which the first projecting portion that satisfies the expressions (1) and (2) above is provided in all of first main-surface-side first external electrode 122a, second main-surface-side first external electrode 122b, first side-surface-side first external electrode 123a, and second side-surface-side first external electrode 123b in multilayer ceramic capacitor 100 according to the present example embodiment described above is illustrated, such a first projecting portion should only be provided in at least any one of first main-surface-side first external electrode 122a, second main-surface-side first external electrode 122b, first side-surface-side first external electrode 123a, and second side-surface-side first external electrode 123b. In this case, the first projecting portion is preferably provided in a portion of first external electrode 120 located opposite to a mount surface (second main surface 112 in the present example embodiment). This is because concentration of stress is particularly likely in that portion of first external electrode 120.

Although an example in which second main surface 112 is defined as the mount surface in multilayer ceramic capacitor 100 according to the present example embodiment described above is illustrated, the mount surface is not particularly limited to second main surface 112 and any of first main surface 111, first side surface 113, and second side surface 114 may be defined as the mount surface.

Although an example in which second projecting portion 132a1 or the like is provided in second external electrode 130 in multilayer ceramic capacitor 100 according to the present example embodiment described above is further illustrated, second projecting portion 132a1 or the like does not necessarily have to be provided in second external electrode 130.

Although an example in which first external electrode 120 and second external electrode 130 each include underlying electrode layer 160 and plated layer 170 in multilayer ceramic capacitor 100 according to the present example embodiment described above is illustrated, first external electrode 120 and second external electrode 130 may each include only underlying electrode layer 160.

### First Modification

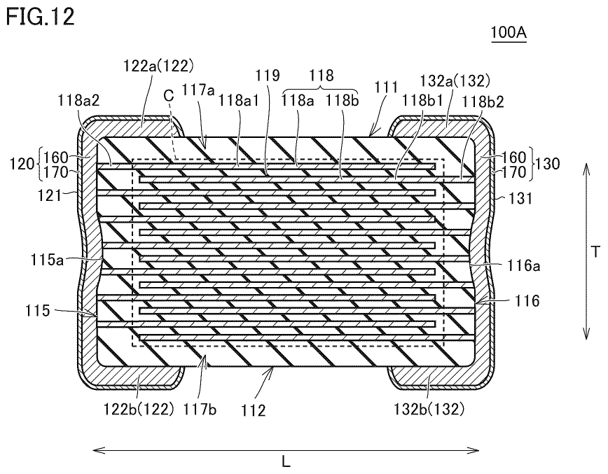

FIG. 12 is a schematic cross-sectional view of a multilayer ceramic capacitor according to a first modification of an example embodiment of the present invention. More specifically, FIG. 12 is a schematic cross-sectional view of a portion corresponding to FIG. 2, of the multilayer ceramic capacitor according to the first modification. A multilayer ceramic capacitor 100A according to the first modification based on the example embodiment described above will be described below with reference to FIG. 12.

As shown in FIG. 12, multilayer ceramic capacitor 100A according to the present modification is different from multilayer ceramic capacitor 100 according to the example embodiment described above in the configuration of first end surface 115 and second end surface 116 of element body portion 110.

More specifically, in multilayer ceramic capacitor 100A, a central portion of each of first end surface 115 and second end surface 116 is recessed. In accordance therewith, end-surface-side first external electrode 121 is recessed along a recess 115a provided in first end surface 115. Similarly, end-surface-side second external electrode 131 is recessed along a recess 116a provided in second end surface 116.

A depth of recess 115a is, for example, preferably equal to or smaller than about 20 μm. The depth is thus set to reduce or prevent solder erosion or the like, which is caused by a relatively small thickness of a portion of end-surface-side first external electrode 121 provided along recess 115a due to a relatively large depth of recess 115a. A depth of recess 116a is also the same or similar.

Such a configuration can also achieve advantageous effects the same as or similar to the advantageous effects described in the example embodiment described above, and the multilayer ceramic capacitor with improved reliability after it is mounted can be obtained.

According to such a configuration, while multilayer ceramic capacitor 100A is mounted on the insulating substrate, a solder fillet enters a recessed portion in end-surface-side first external electrode 121 and a recessed portion of end-surface-side second external electrode 131 and is secured thereto. An area of contact of the solder fillet with end-surface-side first external electrode 121 and end-surface-side second external electrode 131 thus increases. Therefore, multilayer ceramic capacitor 100A can be more securely joined to the insulating substrate.

According to such a configuration, in first immersion of the element body portion in the conductive paste (step S81) described above, introduction of air bubbles in a portion of first conductive paste layer 1001 applied to recesses 115a and 116a is more likely. Accordingly, also in manufacturing of multilayer ceramic capacitor 100A according to the present modification, the element body portion is immersed in the conductive paste a plurality of times. Since such introduction of air bubbles is thus effectively reduced or prevented, an external electrode not including a void having a diameter, for example, equal to or larger than about 1 μm can be formed.

Although an example in which the central portion of each of first end surface 115 and second end surface 116 is recessed is illustrated in the present modification, only one of first end surface 115 and second end surface 116 may be recessed.

### Second Modification

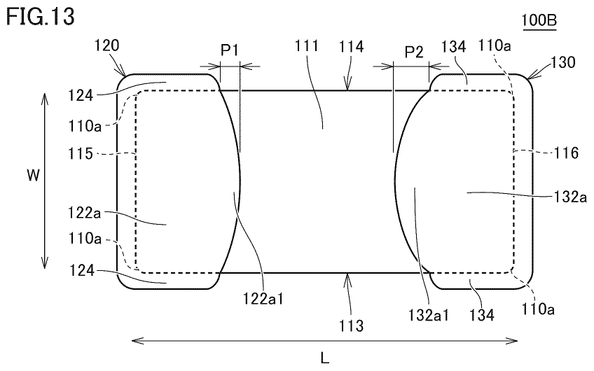

FIG. 13 is a schematic plan view of a multilayer ceramic capacitor according to a second modification of an example embodiment of the present invention. A multilayer ceramic capacitor 100B according to the second modification based on the example embodiment described above will be described below with reference to FIG. 13.

As shown in FIG. 13, multilayer ceramic capacitor 100B according to the present modification is different from multilayer ceramic capacitor 100 according to the example embodiment described above in relation between first projecting portion 122a1 of first main-surface-side first external electrode 122a and second projecting portion 132a1 of first main-surface-side second external electrode 132a.

More specifically, multilayer ceramic capacitor 100B is configured such that P1 denoting the maximum projection length of first projecting portion 122a1 is smaller than P2 denoting the maximum projection length of second projecting portion 132a1. In this case, P1 is, for example, preferably smaller than P2 by about 20 μm or more.

Such a configuration can also achieve advantageous effects comparable to the effect described in the example embodiment described above, and the multilayer ceramic capacitor with improved reliability after it is mounted can be obtained.

According to such a configuration, stress produced in first external electrode 120 due to warpage of the insulating substrate as described above can be further distributed.

Although an example in which P1 is smaller than P2 is illustrated in the present modification, P2 may be smaller than P1. In other words, in the present modification, one of P1 and P2 should only be smaller than the other.

A shape, a configuration, a size, the number, a material, or the like of portions shown in the example embodiments and modifications thereof of the present invention described above can variously be modified within the scope of the present invention.

Characteristic features shown in the example embodiments and the modifications thereof of the present invention described above can be combined within the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
an element body portion including a plurality of dielectric layers and a plurality of internal electrode layers layered in a layering direction, a first main surface and a second main surface opposed to each other in the layering direction, a first side surface and a second side surface opposed to each other in a width direction orthogonal or substantially orthogonal to the layering direction, and a first end surface and a second end surface opposed to each other in a length direction orthogonal or substantially orthogonal to the layering direction and the width direction; and
a first external electrode extending from the first end surface to each of the first main surface, the second main surface, the first side surface, and the second side surface and electrically connected to at least one layer of the plurality of internal electrode layers; wherein
the element body portion includes a ridgeline portion at which two surfaces adjacent to each other among the first main surface, the second main surface, the first side surface, and the second side surface meet each other;
the first external electrode includes:
an end-surface-side first external electrode covering the first end surface;
a main-surface-side first external electrode connected to the end-surface-side first external electrode, and covering a portion of the first main surface and a portion of the second main surface;
a side-surface-side first external electrode connected to the end-surface-side first external electrode, and covering a portion of the first side surface and a portion of the second side surface; and
a ridgeline-portion-side first external electrode connected to the end-surface-side first external electrode, and covering the ridgeline portion;
at least one of the main-surface-side first external electrode and the side-surface-side first external electrode includes a first projecting portion projecting toward a central portion of the element body portion in the length direction, relative to the ridgeline-portion-side first external electrode;
T0 is equal to or larger than about 2.5 mm, where T0 denotes a maximum distance between the first main surface and the second main surface;
W0 is equal to or larger than about 2.5 mm, where W0 denotes a maximum distance between the first side surface and the second side surface; and
expressions (1) and (2) are satisfied:
0.01×T0≤P1≤0.06×T0 (1),
0.01×W0≤P1≤0.06×W0 (2),
where P1 denotes a maximum projection length of the first projecting portion.

2. The multilayer ceramic capacitor according to claim 1, wherein a condition of t1≤about 0.008×L0 is satisfied, where L0 denotes a maximum distance between the first end surface and the second end surface, and t1 denotes a maximum thickness of the end-surface-side first external electrode.

3. The multilayer ceramic capacitor according to claim 1, wherein
at least one of expressions (3) and (4) is satisfied:
0.008×T0≤t2 (3),
0.008×W0≤t3 (4),
where t2 denotes a maximum thickness of the main-surface-side first external electrode and t3 denotes a maximum thickness of the side-surface-side first external electrode.

4. The multilayer ceramic capacitor according to claim 1, wherein a rate of change between average dimensions in the length direction of adjacent portions of four portions of the main-surface-side first external electrode resulting from dividing the main-surface-side first external electrode into four equal or substantially equal portions in the width direction is not greater than about 20%.

5. The multilayer ceramic capacitor according to claim 1, wherein a rate of change of average dimensions in the length direction of adjacent portions of four portions of the side-surface-side first external electrode resulting from dividing the side-surface-side first external electrode into four equal or substantially equal portions in the layering direction is not greater than about 20%.

6. The multilayer ceramic capacitor according to claim 1, further comprising:
a second external electrode extending from the second end surface to each of the first main surface, the second main surface, the first side surface, and the second side surface and electrically connected to at least one other layer of the plurality of internal electrode layers; wherein
the second external electrode includes:
an end-surface-side second external electrode covering the second end surface;
a main-surface-side second external electrode connected to the end-surface-side second external electrode, and covering a portion of the first main surface and a portion of the second main surface;
a side-surface-side second external electrode connected to the end-surface-side second external electrode, and covering a portion of the first side surface and a portion of the second side surface; and
a ridgeline-portion-side second external electrode connected to the end-surface-side second external electrode, and covering the ridgeline portion;
at least one of the main-surface-side second external electrode and the side-surface-side second external electrode includes a second projecting portion projecting toward the central portion of the element body portion in the length direction, relative to the ridgeline-portion-side second external electrode; and
one of P1 and P2 is smaller than the other, where P2 denotes a maximum projection length of the second projecting portion.

7. The multilayer ceramic capacitor according to claim 1, wherein a central portion of each of the first end surface and the second end surface is recessed.

8. The multilayer ceramic capacitor according to claim 1, wherein a maximum distance between the first end surface and the second end surface of the element body is not less than about 3.05 mm and not greater than about 3.2 mm.

9. The multilayer ceramic capacitor according to claim 1, wherein the first external electrode covers an entirety or substantially an entirety of the first end surface.

10. The multilayer ceramic capacitor according to claim 7, wherein the second external electrode covers an entirety or substantially an entirety of the second end surface.

11. The multilayer ceramic capacitor according to claim 1, wherein a total number of the plurality of internal electrode layers is not less than 300 and not greater than 600.

12. The multilayer ceramic capacitor according to claim 1, wherein a thickness of each of the plurality of internal electrode layers is not less than about 0.9 μm and not greater than about 10 μm.

13. The multilayer ceramic capacitor according to claim 1, wherein each of the plurality of internal electrode layers includes Ni, Cu, Ag, Pd, or Au or an alloy including at least one of Ni, Cu, Ag, Pd, or Au.

14. The multilayer ceramic capacitor according to claim 1, wherein a total number of the plurality of dielectric layers includes not less than 300 and not greater than 800.

15. The multilayer ceramic capacitor according to claim 1, wherein each of the plurality of dielectric layers includes BaTiO₃, CaTiO₃, SrTiO₃, or CaZrO₃ as a main component.

16. The multilayer ceramic capacitor according to claim 15, wherein each of the plurality of dielectric layers includes a Mn compound, a Fe compound, a Cr compound, a Co compound, or a Ni compound as a additive.

17. The multilayer ceramic capacitor according to claim 1, wherein a distance between each of the plurality of internal electrode layers and each of the first and second side surface is not less than about 0.8 mm and not greater than about 3.0 mm.

18. The multilayer ceramic capacitor according to claim 1, wherein the first external electrode includes an underlying electrode layer and a plated layer covering the underlying electrode layer.

19. The multilayer ceramic capacitor according to claim 18, wherein the underlying electrode layer includes at least one of a baked layer, a resin layer, or a thin-film layer.

20. The multilayer ceramic capacitor according to claim 18, wherein the plated layer includes Ni, Cu, Ag, Pd, or Au or an alloy including at least one of Ni, Cu, Ag, Pd, or Au.
